(19) United States
(12) Patent Application Publication
(10) Pub. No.: US 2018/0170077 A1
(43) Pub. Date: Jun. 21, 2018

(54) PRINTER WITH IMAGE INSPECTION DEVICE

(71) Applicant: Océ Holding B.V., Venlo (NL)

(72) Inventor: Mircea NISTOR, Timisoara (RO)

(73) Assignee: Océ Holding B.V., Venlo (NL)

(21) Appl. No.: 15/833,657

(22) Filed: Dec. 6, 2017

(30) Foreign Application Priority Data
Dec. 16, 2016 (EP) 16204625.4

(51) Int. Cl. B41J 13/00; G03G 15/00; B41J 11/66

(52) U.S. Cl. CPC B41J 13/0009; B41J 11/663; G03G 15/6582

(57) ABSTRACT

A printer includes an image forming station; a first media transport path arranged to convey printed media from the image forming station to an output port; a second media transport path branching off from the first media transport path and arranged to convey printed media to a reject port; a switch for directing printed media into the second media transport path; an image inspection device for inspecting images printed onto the media; and a decision unit arranged to decide, on the basis of an inspection result obtained from the image inspection device, whether a printed image shall be rejected, and arranged to control the switch. The printer is a roll-to-sheet printer having a roll from which the media are supplied into the first media support path in the form of an endless web. The printer includes a cutting device for cutting the web; and the decision unit is arranged to cause a reversal of the transport direction of the media in the first media transport path, thereby to move an edge of the printed media to the position of the switch.

### BACKGROUND OF THE INVENTION

### 1. Field of the Invention

The invention relates to a printer comprising:
an image forming station;
a first media transport path arranged to convey printed media from the image forming station to an output port;
a second media transport path branching off from the first media transport path and arranged to convey printed media to a reject port;
a switch for directing printed media into the second media transport path;
an image inspection device for inspecting images printed onto the media; and
a decision unit arranged to decide, on the basis of an inspection result obtained from the image inspection device, whether a printed image shall be rejected, and arranged to control the switch.

### 2. Description of Background Art

US 2011/075 193 A1 discloses a cut-sheet printer which has the features listed above.

### SUMMARY OF THE INVENTION

It is an object of the invention to provide a roll-to-sheet printer which is capable of automatically separating defective prints from acceptable prints and which has a compact design.

In order to achieve this object, the printer according to the invention is characterized in that:
the printer is a roll-to-sheet printer having a roll from which the media are supplied into the first media transport path in the form of an endless web, the printer comprising a cutting device for cutting the web;
the decision unit is arranged to cause a reversal of the transport direction of the media in the first media transport path, thereby to move an edge of the printed media to the position of the switch.

The problem with roll-to-sheet printers is that the printed images, since they are printed on an endless web, may have considerably large dimensions in the media transport direction. Since a decision whether or not a printed image shall be rejected because of artefacts contained in the image can be taken only after the last pixel line of the image has been inspected, a conventional design would require that the switch is disposed at a sufficiently large distance from the image inspection device so that the web carrying the printed image or, if the web has been cut already, the sheet carrying the printed image can still be directed into the second media transport path at the switch. The invention solves this problem by reversing the transport direction of the media in the first media transport path. This permits to arrange the switch in close proximity to the image inspection device and to allow for situations in which a leading edge of the web or sheet has passed the switch already when an artefact is detected and is decided that the print should be discarded. In such a situation, the web or sheet will be moved in the direction opposite to the original transport direction until an edge of the web or sheet has been returned to the position of the switch, so that the switch may direct to the web or sheet into the second media transport path leading to the reject port.

More specific optional features of the invention are indicated in the dependent claims.

It will be appreciated that the present invention may be applied to any type of roll-to-sheet printer, regardless of the type image forming station applied, as artifacts in the print media occur for any type of image forming station, for example print artifacts, transport artifacts, alignments artifacts, specifically wrinkles, tears, banding of the printed image or swaths thereof, and/or misalignment of the printed image on the media. Preferably, the printing system is an inkjet roll-to-sheet printing system, but the present invention may be applied to roll-to-sheet printing systems with other image forming stations such as toner-based systems.

In en embodiment, the image inspection device is arranged downstream of the image forming station and upstream of the output port. In another embodiment, the switch is arranged to deflect media that move in the first media transport path in a reverse direction into the second media transport path.

In an embodiment, the switch is arranged to deflect media that move in the first media transport path in a reverse direction into the second media transport path after a trailing edge of said media has passed the switch in the transport direction. Thereby, the media is directed to the output port onto the output tray. From the output tray, the media may be reversed into the second transport path with the former trailing edge as the present leading edge of the media. As such, the output tray is utilized for temporarily holding or supporting the media while the media is sensed by the image inspection device. The length of the transport path of the printing system may thus be relatively compact.

In an embodiment, the image inspection device is arranged downstream of the image forming station and upstream of the switch. This allows for an even more compact embodiment.

In a further embodiment, the switch is arranged downstream of the image forming station and upstream of the output port. The media may thus be reversed from the output tray onto the second transport path. Both the image inspection device and the switch may thus be positioned relatively near the image forming station.

In another embodiment, the printing system according to the present invention further comprises a controller configured for:
transporting printed media in the transport direction over the first media transport path until a trailing edge of the media passes the switch;
when the decision unit causes a reversal of the transport direction of the media in the first media transport path, controlling the switch to direct said edge of the media in the reverse direction via the switch onto the second media transport path. The controller first transports the media in the transport direction over the first transport path until the trailing edge passes the switch. The trailing edge also passes the image inspection device, such that the printed image may be inspected in full or completely (though the inspection may be terminated earlier when a critical artifact has been detected). The decision unit then decides on the quality of the printed image. If deemed unsuitable, the switch is controlled to direct the media from the output tray into the second transport path by reversing the direction of the media. The trailing edge therein becomes the leading edge which leads the media past the switch into the second transport path.

In one embodiment the switch may be arranged to deflect the media into the second media transport path when the media moves in reverse direction. In that case the part of the web carrying the printed image is cut when a defect in the printed image has been detected. Thereafter, the cut sheet is moved in the reverse direction and the switch will direct it into the reject port.

In another embodiment the switch may be arranged to deflect the media into the second media transport path when the media moves in the regular transport direction. In that case, when a defect is detected, the web or sheet is at first moved in the reverse direction until the leading edge of the web or sheet has reached again a position upstream of the switch. Then, when the media is again moved in forward direction, the switch will deflect it towards the reject port.

The cutting device for cutting the web may be arranged upstream or downstream of the image forming station. It is preferred that the cutting device is disposed downstream of the image forming station so as to cut the web only after an image has been printed. In that case, when it is decided that a print shall be rejected, the print process may be stopped immediately and the cutting device may be used to cut-off only the length of the web on which a part of the image had been printed until the defect was detected. This will reduce the amount of waste produced when images are rejected. In another embodiment, the cutting device may provided upstream of the image forming unit, e.g. in or near a web feeding unit holding the roll.

The second media transport path may contain a shredder for immediately shredding the rejected images.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIGS. 1 to 3 are schematic views of a printer according to the invention in different operational states;

FIGS. 4 to 6 are views analogous to FIGS. 1 to 3 and show another embodiment of the invention; and

FIG. 7 is a block diagram illustrating the operation of a printer according to the invention.

### DETAILED DESCRIPTION OF THE PREFERRED EMBODIMENTS

The present invention will now be described with reference to the accompanying drawings, wherein the same reference numerals have been used to identify the same or similar elements throughout the several views.

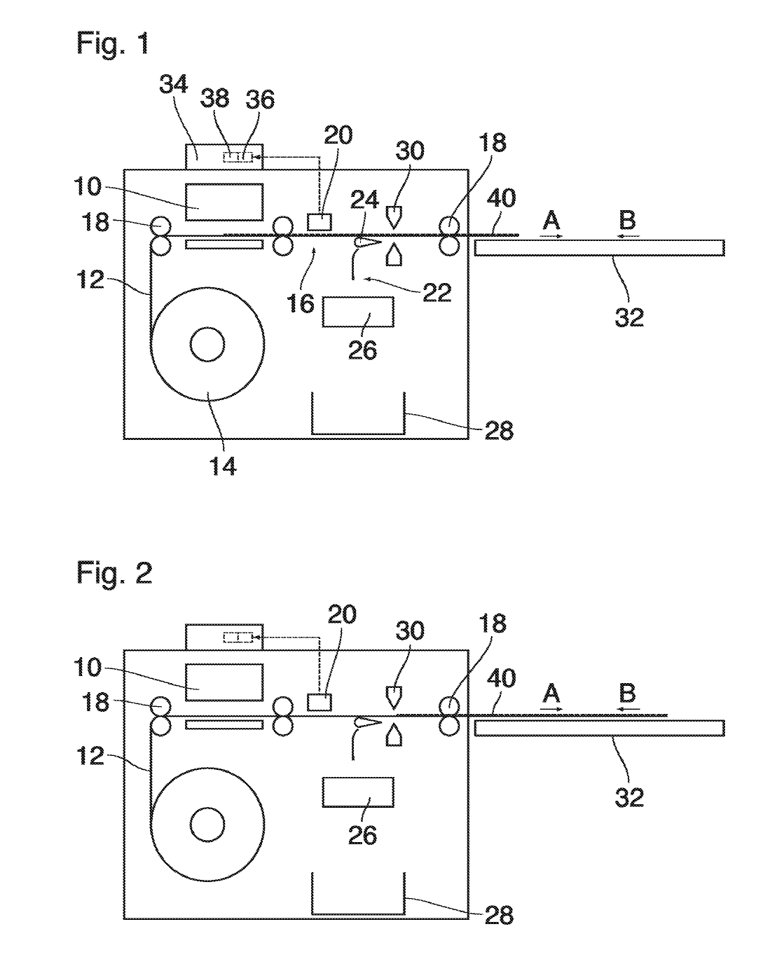

As is shown in FIG. 1, a printer according to the invention comprises an image forming station 10 arranged to form an image on a media that takes the form of an endless web 12 and is withdrawn from a roll 14. A first media transport path 16 is arranged to transport the web past the image forming station 10 and comprises pairs of feed rollers 18 which may be driven to move the web 12 either in a forward direction A or a rearward direction B.

An image inspection device 20 comprises a camera that is disposed at the media transport path 16 in a position downstream of the image forming station 10 so as to inspect an image that has just been printed onto the web in the image forming station 10.

A second media transport path 22 is arranged to branch off from the first media transport path 16 at a switch 24 and contains a shredder 26 and a reject bin 28 constituting a reject port of the printer.

A cutting device 30 is arranged at the first media transport path 16 in a position downstream of the switch 24 and serves for cutting the web 12 into separate sheets. In a normal mode of operation of the printer the web 12 is moved in the forward direction A and images are printed on successive portions of the web by means of the image forming station 10. When a trailing edge of a printed image reaches the position of the cutting device 30, the web 12 is cut (possibly with temporary interruption of the movement of the web), and then the cut sheet carrying the printed image is conveyed to an output port 32 of the printer, the output port being constituted by a tray, for example.

In this example, the image forming station 10 has a page-wide print head which extends over the entire width of the web 12 (in the direction normal to the plane of the drawing in FIG. 1). This permits to operate the printer in a highly productive single-pass mode in which each portion of the web 12 is moved past the image forming station 10 only once. However, in case of a malfunction of the image forming station 10, there is no possibility to correct any artefacts that the malfunction may have produced in the printed image. For example, the image forming station 10 may be an ink jet printer, and a malfunction may consist in one or more nozzles of the print head becoming clogged. The resulting artefact will be a number of missing lines (in lengthwise direction of the web) in the printed image.

The inspection device 20 is provided for automatically detecting such artefacts by comparing an image captured from the web 12 by means of the camera to a reference image that is stored in a controller 34 of the printer and from which the print instructions for the image forming station 10 have been derived. To that end, the controller 34 comprises an image processing component 36 and a decision unit 38 which decides whether the detected artefacts are still acceptable or whether they are so severe that the printed image should be rejected.

In FIG. 1, a portion of a web 12 on which a part 40 of an image has already been printed is designated by a broken line. The part 40 of the image extends from a leading edge of the web 12 (already on the tray forming the output port 32) to the position of the image forming station 10. It shall now be assumed that, in the very moment that has been depicted in FIG. 1, the inspection device 20 detects a severe artefact and the decision unit 38 decides that the image shall be rejected. Thereupon the controller 34 immediately aborts the print process, although the printed image is not jet complete. Since the part of the web that carries the rejected image will be discarded, the immediate abortion of the print process avoids the production of unnecessary waste. Then, under the control of the controller 34, the web 12 is conveyed further in the forward direction A until the trailing edge of the printed part 40 of the image reaches the position of the cutting device 30, as has been shown in FIG. 2. Since the distance between the print position of the image forming station 10 and the position of the cutting device 30 is known, the feed rollers 18 may be controlled to convey the web 12 over that known distance. Optionally, the image inspection device 20 may be used for checking the advance of the web by detecting the time at which the trailing edge of the printed part 40 of the image passes the inspection device.

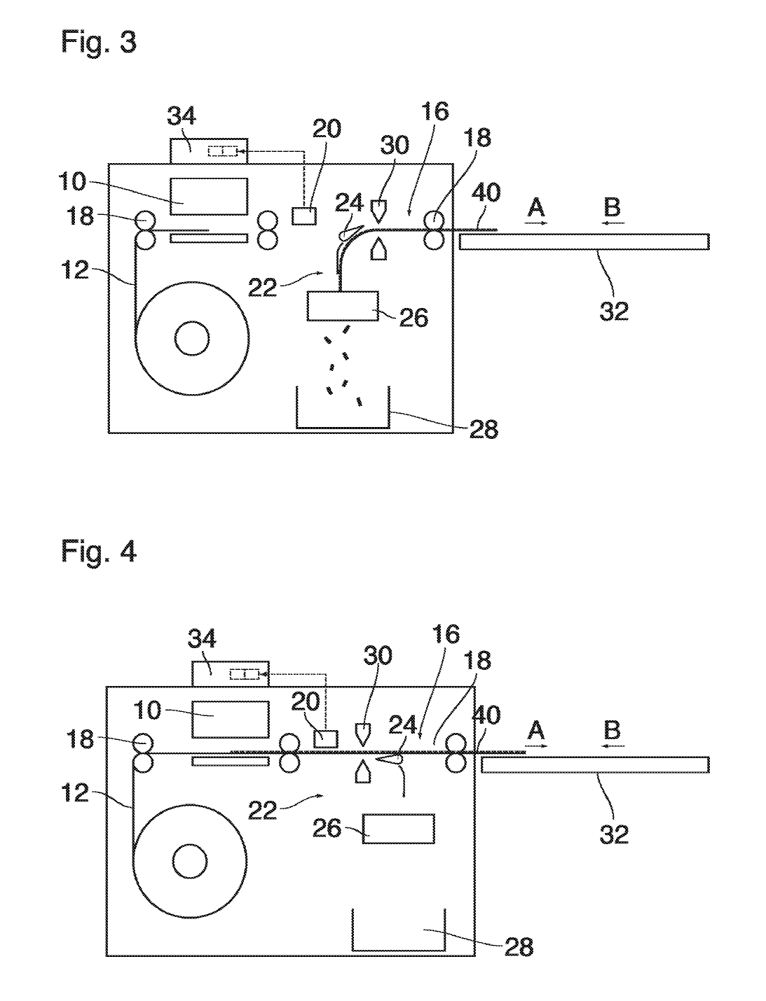

In the situation shown in FIG. 2, the cutting device 30 is actuated for cutting the sheet. Then, the upstream part of the web 12 is transported in reverse direction until the new leading edge of the web which has just been produced by the cutting device reaches again the print position at the image forming station 10. This condition of the web 12 has been illustrated in FIG. 3.

The withdrawal of the web has produced a gap between the web 12 and the cut sheet bearing the part 40 of the printed image. This gap exists in particular at the position of the switch 24 which can therefore be pivoted into the position shown in FIG. 3. Then, the feed rollers 18 at the downstream side of the first media transport path 16 are driven to move the cut sheet in the reverse direction B. Consequently, the edge of the cut sheet which is now the leading edge (due to the reversal of the direction of movement) will be deflected at the switch 24 into the second media transport path 22 where the sheet is shredded with the shredder 26 and the shreds are collected in the reject bin 28.

Meanwhile, the controller 34 will command a maintenance cycle to be performed for the image forming station 10 in order to clean the print head and thereby to remove the cause for the artefacts. When the maintenance cycle has been completed and the rejected sheet has been shredded completely and therefore has left the first media transport path 16, the print process may be resumed with printing a new copy of the image that has been rejected.

Since information about the length of an image to be printed is available in the controller 34, the cutting device 30 might also be provided on the upstream side of the image forming station 10 in a modified embodiment. In that case, the images would be printed on sheets that have already been cut from the web 12. However, the length of the cut sheet would then be fixed already at the time when an artefact is detected by the inspection device 20. Consequently, the entire cut sheet would have to be rejected and the waste could not be reduced by stopping the print process immediately when the artefact is detected. It is therefore preferred that the cutting device 30 is provided on the downstream side of the image forming station 10.

For the same reason, it is preferred that the image inspection device 20 is disposed as closely as possible to the image forming station 10 so that artefacts can be detected with only a little delay and the print process can be aborted early. In principle, it would also be possible, however, to arrange the inspection device 20 downstream of the switch 24 or even downstream of the cutting device 30.

FIGS. 4 to 6 illustrate a modified embodiment in which the orientation of the switch 24 and the sequence of the cutting device 30 and the switch 24 have been reversed.

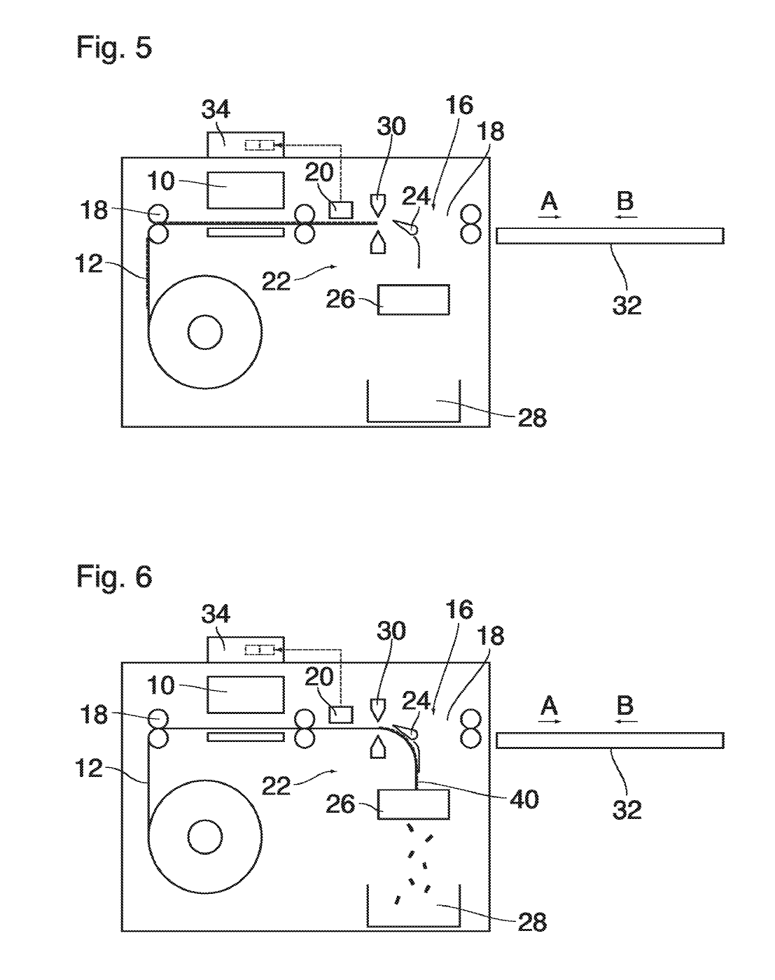

FIG. 4 illustrates again the moment at which the artefact is detected and the print process is aborted. At this instant, the direction of transport of the web 12 is reversed and the web is withdrawn to the position shown in FIG. 5, i.e. a position where the leading edge of the web (in forward direction) is upstream of the switch 24. Then, the switch 24 is actuated and the direction of transport of the web 12 is reversed again so that the web will be deflected into the second media transport part 22 and the leading portion of the web will be shredded, as shown in FIG. 6.

When the trailing edge of the printed part 40 has reached the position of the cutting device 30, the cutting device is actuated for cutting the web. While the rest of the cut sheet will be shredded, the main part of the web 12 will be withdrawn until the leading edge has again reached the print position at the image forming station 10, so that a new print process may start for recovering the rejected image.

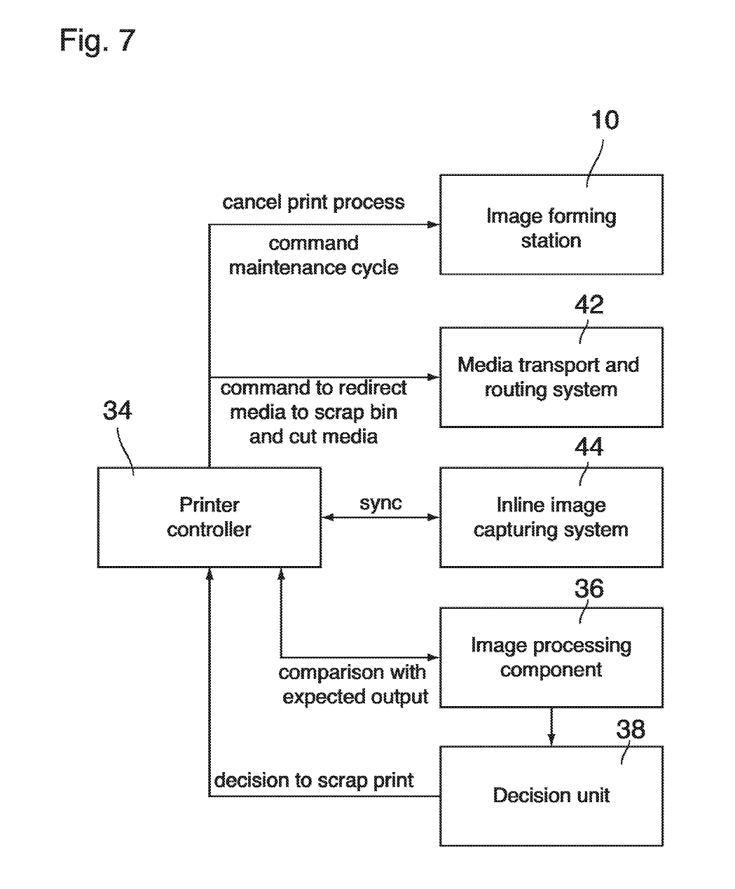

FIG. 7 is a block diagram showing the essential components of a printer according to the invention and its control system. The controller 34 controls the operation of the image forming station 10 as well as the operations of a media transport and routing system 42 which comprises among others the feed rollers 18, the cutting device 30, the switch 24 and the shredder 26. An inline image capturing system 44 (camera) constitutes the sensor part of the image inspection device 20 and operates in synchronism with the operations of the printer as controlled by the controller 34.

For the sake of clarity, the image processing component 36 and the decision unit 38 have been shown here as separate blocks, although these components may in practice be integrated in the controller 34.

When, by comparing the captured image with the expected output, the image processing component 36 detects an artefact, the decision unit 38 is activated to decide whether the artefact is tolerable or leads to a rejection of the print. In the latter case, a signal that the print shall be rejected and scrapped is sent to the controller 34, which thereupon cancels the print process and then controls the media transport and routing system 42 so as to redirect the media to be scrapped into the second media transport path 22 and to separate it from the main web appropriately. Further, the controller 34 commands a maintenance cycle for the image forming station, so that the printer will be ready for printing again without producing artefacts.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A printer comprising:
an image forming station;
a first media transport path arranged to convey printed media from the image forming station to an output port;
a second media transport path branching off from the first media transport path and arranged to convey printed media to a reject port;
a switch for directing printed media into the second media transport path;
an image inspection device for inspecting images printed onto the media; and
a decision unit arranged to decide, on the basis of an inspection result obtained from the image inspection device, whether a printed image shall be rejected, and arranged to control the switch;
the printer is a roll-to-sheet printer having a roll from which the media are supplied into the first media support path in the form of an endless web, the printer comprising a cutting device for cutting the web; and
the decision unit is arranged to cause a reversal of the transport direction of the media in the first media transport path, thereby to move an edge of the printed media to the position of the switch.

2. The printer according to claim 1, wherein the image inspection device is arranged downstream of the image forming station and upstream of the output port.

3. The printer according to claim 1, wherein the image inspection device is arranged downstream of the image forming station and upstream of the switch.

4. The printer according to claim 1, wherein the switch is arranged to deflect media that move in the first media transport path in a reverse direction into the second media transport path after a trailing edge of said media has passed the switch in the transport direction.

5. The printer according to claim 1, wherein the switch is arranged downstream of the image forming station and upstream of the output port.

6. The printer according to claim 1, wherein a shredder is arranged in the second media transport path.

7. The printer according to claim 1, wherein the cutting device is arranged downstream of the image forming station.

8. The printer according to claim 1, wherein the image inspection device is arranged downstream of the image forming station and upstream of the switch.

9. The printer according to claim 8, wherein the switch is arranged to deflect media that move in the first media transport path in a reverse direction into the second media transport path.

10. The printer according to claim 1, wherein the switch is arranged to deflect media that move in the first media transport path in a forward direction into the second media transport path, and the cutting device is disposed upstream of the switch.

11. The printer according to claim 1, further comprising a controller configured for:
transporting printed media in the transport direction over the first media transport path such that a trailing edge of the media passes the switch;
when the decision unit causes a reversal of the transport direction of the media in the first media transport path, controlling the switch to direct said edge of the media in the reverse direction via the switch onto the second media transport path.
